(19) United States
(12) Patent Application Publication
(10) Pub. No.: US 2012/0031189 A1
(43) Pub. Date: Feb. 9, 2012

(54) PRESSURE SENSOR

(75) Inventor: Kenta SATO, Kamiina (JP)

(73) Assignee: SEIKO EPSON CORPORATION, Tokyo (JP)

(21) Appl. No.: 13/180,875

(22) Filed: Jul. 12, 2011

(30) Foreign Application Priority Data
Aug. 9, 2010 (JP) 2010-178591

(51) Int. Cl. G01L 9/08; G01L 13/02

(52) U.S. Cl. 73/717; 73/716

(57) ABSTRACT

A pressure sensor includes: a pressure receiving member; and first and second pressure sensitive elements which have a pressure sensing portion and a pair of base portions connected to both ends of the pressure sensing portion, and which have a detection axis parallel to a line connecting the base portions, and in which the detection axis is parallel to a displacement direction of the flexible portion. One base portion of the first pressure sensitive element is fixed to the flexible portion, and the other base portion is fixed to a first supporting member that is supported by the peripheral portion. One base portion of the second pressure sensitive element is fixed to the peripheral portion, and the other base portion is fixed to a second supporting member that is supported by the flexible portion.

### BACKGROUND

1. Technical Field

The invention relates to a pressure sensor, and more particularly, to a pressure sensor which uses two pressure sensitive elements and operates the two pressure sensitive elements differentially to improve detection sensitivity, temperature property, and the like.

2. Related Art

In the related art, pressure sensors which use a piezoelectric vibrating element as a pressure sensitive element are known, such as a hydraulic pressure meter, a barometer, a differential pressure meter, and the like. In a pressure sensor using a piezoelectric vibrating element, when pressure is applied to the piezoelectric vibrating element in the detection axis direction thereof, the resonance frequency of the piezoelectric vibrating element changes, and pressure applied to the pressure sensor is detected from a change in the resonance frequency.

JP-A-56-119519, JP-A-64-9331, and JP-A-2-228534 disclose pressure sensors in which a piezoelectric vibrating element is used as a pressure sensitive element. When pressure is applied to a bellows through a pressure inlet opening, a force corresponding to the effective area of the bellows is applied to a piezoelectric vibrating element as a compressive force or a tensile force (extensional force) F through a force transmission member in which a pivot (flexible hinge) is used as a fulcrum. A stress corresponding to the force F occurs in the piezoelectric vibrating element, and the resonance frequency of the piezoelectric vibrating element changes due to the stress. The pressure sensor can calculate the applied pressure by detecting a change in the resonance frequency of the piezoelectric vibrating element.

FIG. 10 is a cross-sectional view showing a configuration of a pressure sensor disclosed in JP-A-56-119519. The pressure sensor includes a housing 104 having first and second pressure inlet openings 102 and 103, and a force transmission member 105 disposed inside the housing 104. A first bellows 106 and a second bellows 107 are connected with one end of the force transmission member 105 disposed therebetween. Moreover, an opening on the other end of the first bellows 106 is connected to the first pressure inlet opening 102, and an opening on the other end of the second bellows 107 is connected to the second pressure inlet opening 103. Furthermore, a double-ended vibrating element 109 serving as a pressure sensitive element is disposed between the other end of the force transmission member 105 and an end portion of a substrate 108 which is on the opposite end of a pivot (fulcrum) of the substrate 108.

When detecting pressure with high accuracy, liquid is filled in the bellows. As the liquid, silicone oil or the like having high viscosity is generally used in order to prevent bubbles from entering and accumulating inside the bellows or between the folds of the bellows. That is, viscous oil 110 is filled in the first bellows 106. When liquid is a pressure measurement target, the oil 110 contacts and faces the liquid through an opening 111 opened to the first pressure inlet opening 102. The size of the opening 111 is set so as to prevent leakage of the oil 110.

FIG. 11 is a cross-sectional view showing a configuration of a pressure sensor disclosed in JP-A-2-228534. A pressure sensor 150 shown in FIG. 11 includes a housing 120, a pressure inlet opening 121, and bellows 122a and 122b. A force transmission member 125 is connected to the bellows 122a and 122b, and a pressure sensitive element 130 is attached and fixed between a flexible portion 125a and a fixing portion 125b of the force transmission member 125. When pressure is applied to the bellows 122a and 122b through the pressure inlet opening 121 of the pressure sensor 150, force corresponding to the effective area of the bellows 122a and 122b is applied to the force transmission member 125 in the vertical direction. Force corresponding to differential pressure is applied to the pressure sensitive element 130 as a compressive force or a tensile force (extensional force) with a pivot 135 used as a fulcrum. The resonance frequency of the pressure sensitive element 130 changes with this force, and the pressure sensor 150 measures pressure by detecting the change in the resonance frequency.

The bellows 122a and 122b, the force transmission member 125, the pressure sensitive element 130, and the housing 120 are formed of different materials. As a result, thermal deformation occurs due to a change in the temperature of the use environment, which deteriorates pressure measurement accuracy. Therefore, a supporting portion of the pressure sensitive element 130 is arranged to be separated from a flexible portion 125a of the force transmission member 125 and the force transmission member 125. Moreover, the supporting portion is cross-linked to a fixing member 140 of the pressure sensitive element 130 provided in the housing 120. In this way, thermal deformation due to a change in ambient temperature is prevented from affecting the pressure sensitive element 130.

Moreover, the thermal deformation of the bellows line, the force transmission member, a force transmission member supporting portion, and the pressure sensitive element fixing portion were separated and analyzed for thermal deformation. For example, stainless steel, nickel, phosphor bronze, and quartz crystal were used for the housing, the bellows, the force transmission member, and the pressure sensitive element, respectively, and the respective linear expansion coefficients were used in the analysis. JP-A-2-228534 describes that when the dimensions of the respective members are set, and the linear expansion coefficient of the fixing member of the pressure sensitive element 130 is set, it is possible to calculate the optimum length of the fixing member and to realize a pressure sensor which is not affected by thermal deformation.

However, in the pressure sensor 101 disclosed in JP-A-56-119519, the oil 110 filled in the first bellows 106 shown in FIG. 10 has a higher thermal expansion coefficient than other constituent elements, for example, the force transmission member 105, the double-ended vibrating element 109, and the like. Thus, the oil 110 causes thermal deformation in the respective constituent members of the pressure sensor 101 due to a change in temperature. Stress due to this thermal deformation is superimposed on the signal of the double-ended vibrating element 109 as noise, and measurement accuracy of the pressure sensor deteriorates.

Moreover, the oil 110 filled in the first bellows 106 contacts and faces the liquid which is the pressure measurement target. However, depending on a method of installing the pressure sensor, the oil may flow toward the liquid which is the pressure measurement target, and the liquid may flow into the first bellows 106. Thus, there is a possibility that bubbles are formed in the oil 110 filled in the first bellows 106. If bubbles are formed in the oil 110, the bubbles absorb pressure, and the oil does not properly function as a pressure transmission medium. Thus, there is a possibility that errors occur in the measured pressure value.

Furthermore, since the oil 110 is in contact with the liquid which is the pressure measurement target, depending on a method of installing the pressure sensor, there is a possibility that the oil 110 flows toward the liquid which is the pressure measurement target. Thus, a pressure sensor which uses the oil 110 as in the related art may not be used for fluid-pressure measurement where mixing of foreign materials is to be prevented.

Moreover, in the pressure sensors disclosed in JP-A-56-119519 and JP-A-2-228534, the force transmission members 105 and 125 have a complex structure, which makes it difficult to miniaturize the pressure sensors. Moreover, the force transmission members 105 and 125 are components which require a flexible hinge having a narrow waist portion, which increases the manufacturing costs of the pressure sensor.

In order to solve such a problem, JP-A-2010-48798 discloses a pressure sensor 210 as shown in the cross-sectional view of FIG. 12. The pressure sensor 210 includes a housing 212, a pressure receiving member (diaphragm 224) which seals an opening 222 of the housing 212 and includes a flexible portion (central region 224a) and a peripheral region 224c positioned on the outer side of the flexible portion, and in which one principal surface of the flexible portion is a pressure receiving surface, and a pressure sensitive element 240 which includes a pressure sensing portion and first and second base portions 240a and 240b respectively connected to both ends of the pressure sensing portion, and in which an arrangement direction of the first and second base portions 240a and 240b is parallel to a displacement direction of the diaphragm 224. In the pressure sensor 210, the first base portion 240a is connected to a central region 224a of the diaphragm 224, which is the rear side of the pressure receiving surface, and the second base portion 240b is connected to the peripheral region 224c on the rear side, or to an inner wall of the housing 212 facing the first base portion 240a, through a connecting member 242.

With this configuration, force corresponding to the displacement of the pressure receiving member can be directly applied to the pressure sensitive element 240 as compressive force without through the flexible hinge described above. Thus, it is possible to improve sensitivity. Moreover, it is possible to widen measurement targets since it does not use oil. In addition, in the pressure sensitive element 240, since the first base portion 240a is fixed to the pressure receiving member and the second base portion 240b is fixed to the side of the pressure receiving member through the connecting member 242, it is possible to alleviate a thermal deformation problem. Moreover, since the connecting member 242 and the pressure sensitive element 240 are integrally formed using a piezoelectric material, it is possible to alleviate thermal deformation further. The above configuration can be used as a fluid pressure sensor which measures fluid pressure with reference to atmospheric pressure by making the inside of the housing 212 open to atmospheric pressure. In this case, tensile force as well as compressive force can be applied to the pressure sensitive element 240.

However, in the above configuration, since thermal expansion and thermal contraction occur due to a change in the temperature of the pressure sensitive element and the connecting member, there is a problem in that it is difficult to suppress a change in the resonance frequency of the pressure sensitive element due to the thermal expansion. There is also a problem in that the resonance frequency of the pressure sensitive element changes with time.

### SUMMARY

An advantage of some aspects of the invention is that it provides a pressure sensor capable of measuring pressure stably by suppressing problems associated with a change in temperature, aging, and the like.

### APPLICATION EXAMPLE 1

This application example of the invention is directed to a pressure sensor including: a pressure receiving member having a flexible portion that is displaced in response to force and a peripheral portion connected to an outer periphery of the flexible portion; and first and second pressure sensitive elements which have a pressure sensing portion and a pair of base portions connected to both ends of the pressure sensing portion, and which have a detection axis parallel to a line connecting the base portions, and in which the detection axis is parallel to a displacement direction of the flexible portion, wherein one base portion of the first pressure sensitive element is fixed to the flexible portion, and the other base portion is fixed to a first supporting member that is supported by the peripheral portion, and wherein one base portion of the second pressure sensitive element is fixed to the peripheral portion, and the other base portion is fixed to a second supporting member that is supported by the flexible portion.

With this configuration, when the flexible portion is displaced toward the outer side of the housing, the first pressure sensitive element receives tensile stress from the flexible portion and the first supporting member that is supported by the peripheral portion, and the second pressure sensitive element receives compressive stress from the flexible portion through the second supporting member that is supported by the flexible portion. In contrast, when the flexible portion is displaced toward the inner side of the housing, the first pressure sensitive element receives compressive stress from the first supporting member, and the second pressure sensitive element receives tensile stress from the flexible portion through the second supporting member. The resonance frequencies of the respective pressure sensitive elements increase in response to tensile stress and decrease in response to compressive stress. Therefore, the pressure applied to the flexible portion can be detected by calculating a difference between the resonance frequencies of the first and second pressure sensitive elements. If the first and second pressure sensitive elements are the same constituent elements, since they have the same temperature property and the same aging property with respect to the resonance frequency, these characteristics are canceled in relation to the difference. Therefore, the pressure sensor can measure pressure stably regardless of the temperature property, the aging property, and the like. Moreover, since pressure is measured based on the difference between the resonance frequencies of two pressure sensitive elements, it is possible to obtain higher sensitivity than when using one pressure sensitive element. Furthermore, since at least one base portion of the first and second pressure sensitive elements is fixed to the side of the pressure receiving member, it is possible to decrease the overall size of the pressure sensor.

### APPLICATION EXAMPLE 2

In the pressure sensor of the above application example, the pressure sensing portion may include at least one columnar beam.

With this configuration, when the pressure sensing portion is formed of one columnar beam, since the stress applied to the beam increases, it is possible to improve sensitivity of the pressure sensor.

### APPLICATION EXAMPLE 3

In the pressure sensor of the above application example, the first and second pressure sensitive elements and the first and second supporting members may be integrally formed of a piezoelectric material.

With this configuration, since the respective pressure sensitive elements and the respective supporting members have the same thermal expansion coefficient, it is possible to prevent thermal deformation between the respective pressure sensitive elements and the respective supporting members and to improve the temperature property. Moreover, by integrally forming the respective pressure sensitive elements and the respective supporting members, it is possible to decrease the number of components of the pressure sensor, increase the assembly efficiency of the pressure sensor, and achieve cost reduction.

### APPLICATION EXAMPLE 4

In the pressure sensor of the above application example, the first and second pressure sensitive elements and the first and second supporting members may be formed so that end portions thereof on the sides connected to the pressure receiving member are arranged on a straight line that is vertical to the displacement direction of the flexible portion.

With this configuration, since the respective pressure sensitive elements and the respective supporting members will not receive thermal deformation from the pressure receiving member, the pressure sensor can measure pressure with high accuracy stably against a change in temperature.

### BRIEF DESCRIPTION OF THE DRAWINGS

The invention will be described with reference to the accompanying drawings, wherein like numbers reference like elements.

FIG. 1 is a perspective cross-sectional view of a pressure sensor according to a first embodiment, taken along the XZ plane.

FIGS. 2A and 2B are cross-sectional views of the pressure sensor according to the first embodiment, taken along the XZ and YZ planes, respectively.

FIGS. 3A to 3D show schematic views when a diaphragm is formed of metal.

FIGS. 4A to 4E show schematic views when a diaphragm is formed of quartz crystal.

FIGS. 5A and 5B show modification examples when a diaphragm is formed of quartz crystal.

FIGS. 6A and 6B are cross-sectional views of a pressure sensor according to a modification example of the first embodiment, taken along the XZ and YZ planes, respectively.

FIG. 7 is a perspective cross-sectional view of a pressure sensor according to a second embodiment, taken along the XZ plane.

FIGS. 8A and 8B are cross-sectional views of the pressure sensor according to the second embodiment, taken along the XZ and YZ planes, respectively.

FIGS. 9A to 9E show schematic views when an integral member that integrates first and second pressure sensitive elements and first and second supporting members is formed of quartz crystal.

FIG. 10 is a cross-sectional view showing a configuration of a pressure sensor disclosed in JP-A-56-119519.

FIG. 11 is a cross-sectional view showing a configuration of a pressure sensor disclosed in JP-A-2-228534.

FIG. 12 is a cross-sectional view showing a configuration of a pressure sensor disclosed in JP-A-2010-48798.

### DESCRIPTION OF EXEMPLARY EMBODIMENTS

A pressure sensor according to the invention will be described in detail below with reference to embodiments shown in the accompanying drawings. Note that constituent elements, types, combinations, shapes, relative positions, and the like described in the embodiments are not intended to limit the range of this invention, but are only examples unless there is a specific statement.

### First Embodiment

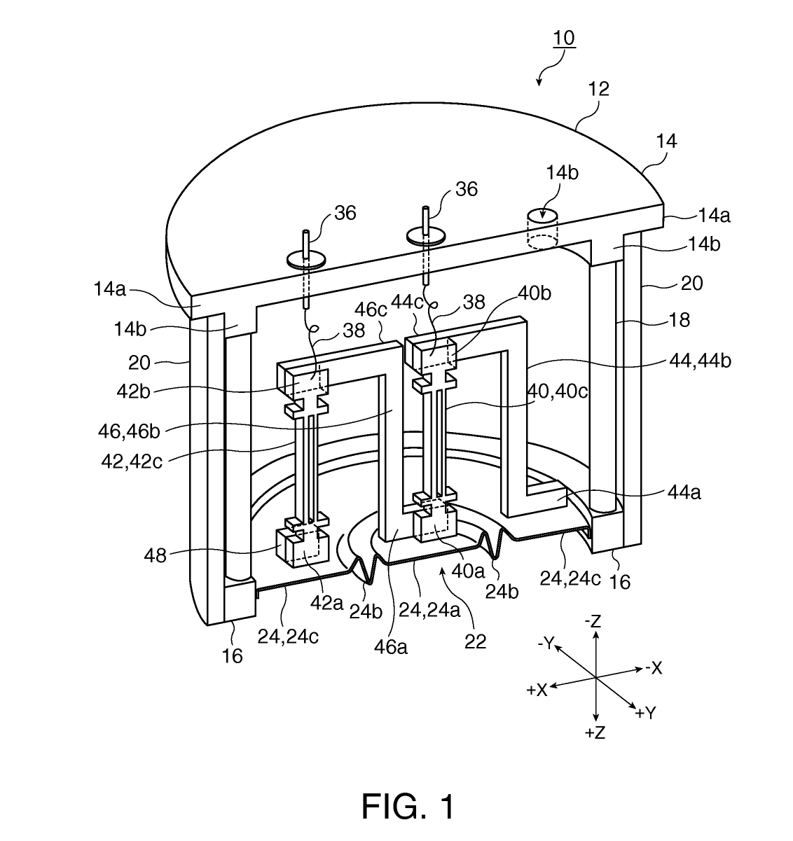

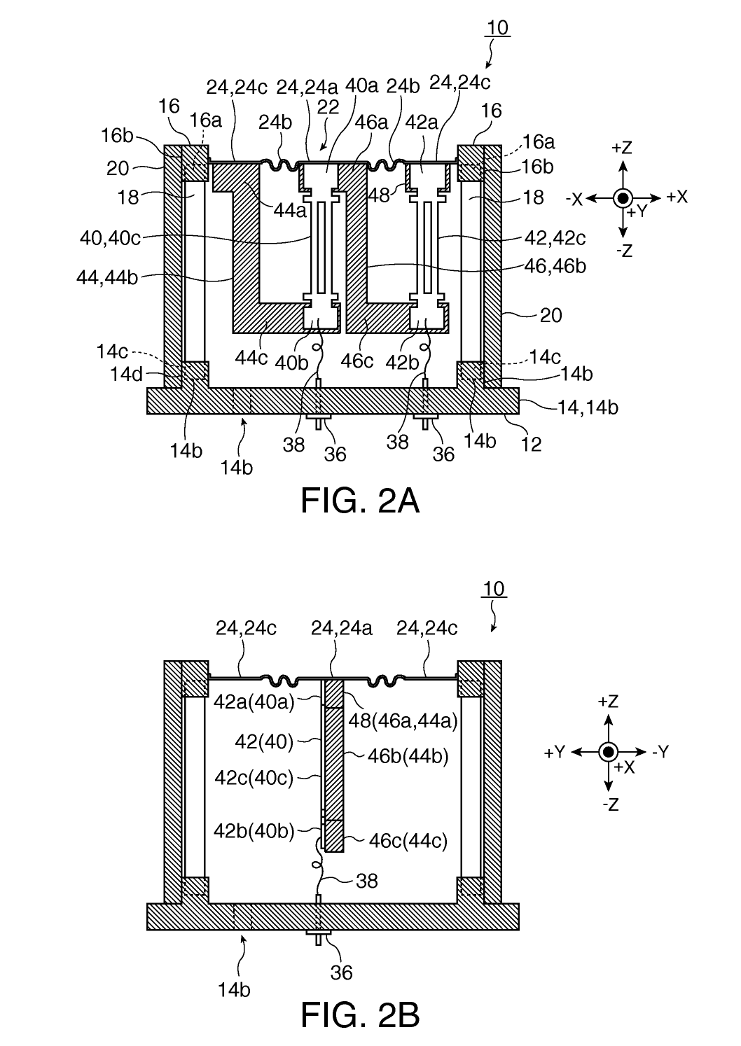

FIG. 1 is a perspective cross-sectional view of a pressure sensor according to a first embodiment, taken along the XZ plane. FIGS. 2A and 2B are cross-sectional views of the pressure sensor according to the first embodiment, taken along the XZ and YZ planes, respectively. Here, the X, Y, and Z axes shown in FIGS. 1, 2A, and 2B constitute an orthogonal coordinate system, and the same is applied to the drawings referred hereinafter. A pressure sensor 10 according to the first embodiment includes a housing 12, a diaphragm 24 serving as a pressure receiving member, first and second pressure sensitive elements 40 and 42, and first and second supporting members 44 and 46. The pressure sensor 10 has a structure in which the housing 12 and the diaphragm 24 serve as a container, and the first and second pressure sensitive elements 40 and 42 are accommodated in the accommodation space of the container having the diaphragm 24. For example, the pressure sensor 10 can be used as a fluid pressure sensor in which the inside of the housing 12 is opened to the atmosphere, and which receives fluid pressure from outside the diaphragm 24 with reference to atmospheric pressure.

The housing 12 includes a circular flange portion 14, a circular ring portion 16, a supporting shaft 18, and cylindrical side surfaces (side walls) 20.

The flange portion 14 includes an outer peripheral portion 14a that is in contact with the end portions of the cylindrical side surfaces (side walls) 20 and an inner peripheral portion 14b that is formed on the outer peripheral portion 14a to be concentric to the outer peripheral portion 14a so as to protrude in a ring shape having the same diameter as the ring portion 16. The ring portion 16 includes a circular opening 22 which is formed by the inner peripheral edge thereof. The diaphragm 24 is connected to the opening 22 so as to seal the opening 22.

Holes 14c and 16a in which supporting shafts 18 are inserted are formed at predetermined positions of the inner peripheral portion 14b of the flange portion 14 and the mutually facing surfaces of the ring portion 16. Moreover, the holes 14c and 16a are formed at the mutually facing positions. Therefore, when the supporting shafts 18 are inserted into the holes 14c and 16a, the flange portion 14 and the ring portion 16 are connected by the supporting shafts 18. The supporting shafts 18 are rod-like members having predetermined rigidity and extending in the ±Z direction. The supporting shafts 18 are disposed inside the container which includes the housing 12 and the diaphragm 24. When one set of ends of the supporting shafts 18 is inserted into the holes 14c of the flange portion 14 and the other set of ends thereof is inserted into the holes 16a of the ring portion 16, predetermined rigidity is obtained between the flange portion 14, the supporting shafts 18, and the ring portion 16. Although a plurality of supporting shafts 18 is used, the arrangement thereof is optional depending on the design of the positions of the respective holes.

Moreover, hermetic terminals 36 are attached to the flange portion 14. The hermetic terminals 36 are configured to be capable of electrically connecting electrode portions (not shown) of the first and second pressure sensitive elements 40 and 42 described later and an integrated circuit (IC, not shown). The IC is used for oscillating the first and second pressure sensitive elements 40 and 42 and calculating a difference between the resonance frequencies of the first and second pressure sensitive elements 40 and 42 and is attached to the outer surface of the housing 12 or is disposed outside the housing 12 to be separated from the housing 12.

Although two hermetic terminals 36 are depicted in FIGS. 1, 2A, and 2B, the hermetic terminals 36 are attached to the flange portion 14 in accordance with the total number of electrode portions of the first and second pressure sensitive elements 40 and 42 described later. Moreover, an air inlet opening 14e is formed on the flange portion 14 so that the inside of the housing 12 can be opened to the atmosphere. The hermetic terminals 36 and the air inlet opening 14e are disposed at any positions of the flange portion 14 such that they do not interfere with each other.

Since both sets of ends of the side surfaces 20 are respectively connected to the outer periphery 14d of the inner peripheral portion 14b of the flange portion 14 and the outer periphery 16b of the ring portion 16 of which the opening 22 is covered by the diaphragm 24, the container is sealed. The flange portion 14, the ring portion 16, and the side surfaces 20 are preferably formed of metal such as stainless steel. The supporting shafts 18 are preferably formed of ceramics or the like having predetermined rigidity and a low thermal expansion coefficient.

One principal surface of the diaphragm 24 facing the outer surface of the housing 12 is configured as a pressure receiving surface. The pressure receiving surface has a flexible portion which is bent and deformed in response to pressure of a pressure measurement environment (for example, liquid). When the flexible portion is bent and deformed to be displaced toward the inner or outer side (Z-axis direction) of the housing 12, the diaphragm 24 transmits Z-axis direction compressive or tensile force to the first and second pressure sensitive elements 40 and 42. Moreover, the diaphragm 24 includes the flexible portion which includes a central region 24a that is displaced by pressure from the outside, and a flexible region 24b that is disposed on the outer periphery of the central region 24a so as to be bent and deformed by the pressure from the outside so as to allow the displacement of the central region 24a, and a peripheral portion 24c that is disposed on the outer side of the flexible portion, namely on the outer periphery of the flexible region 24b and is bonded and fixed to the inner wall of the opening 22 formed in the ring portion 16. Ideally, the peripheral portion 24c is not displaced and the central region 24a is not deformed even when pressure is applied thereto.

The surface of the central region 24a of the diaphragm 24 on the opposite side of the pressure receiving surface is connected to one end in the longitudinal direction (detection axis direction) of the first pressure sensitive element 40 described later. The surface of the central region 24a opposite the pressure receiving surface is attached to the second supporting member 46 described later by an adhesive agent or the like. One end (first base portion 40a) of the first pressure sensitive element 40 described later is fixed to the second supporting member 46 by a fixing material such as an adhesive agent. The surface of the peripheral portion 24c of the diaphragm 24 opposite the pressure receiving surface is connected to the first supporting member 44 described later and the fixing portion 48 described later by a fixing material such as an adhesive agent. The first and second supporting members 44 and 46 and the fixing portion 48 are preferably formed of the same material as the diaphragm 24.

The diaphragm 24 is preferably formed of a material having excellent corrosion resistance such as metal (for example, stainless steel) or ceramics and may be formed of a single crystalline body (for example, quartz crystal) or another amorphous body. For example, when the diaphragm 24 is formed of metal, it may be formed by pressing a base metal material.

When the diaphragm 24 is formed of metal, the base metal material (not shown) may be pressed from both surfaces thereof by a pair of pressing plates (not shown) having recesses (not shown) which correspond to wavy concentric circular shapes of the flexible region 24b of the diaphragm 24.

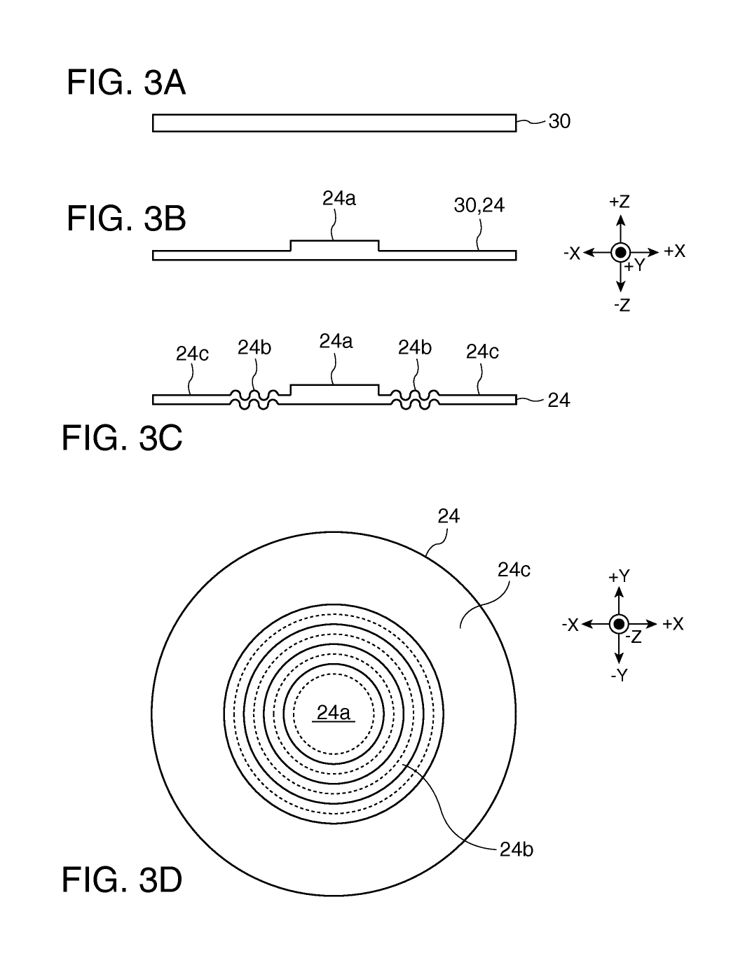

FIGS. 3A to 3E show schematic views when the diaphragm is formed of metal. FIG. 3D is a bottom view of FIG. 3C. In order to suppress the diaphragm 24 from vibrating with a vibration of the first pressure sensitive element 40, the central region 24a of the diaphragm 24 may be made thicker than other regions. In this case, a base metal material 30 is prepared (FIG. 3A), and is subjected to half-etching while leaving the central region 24a (FIG. 3B). Then, the etched base metal material 30 is pressed by a pair of pressing plates (not shown) having a shape corresponding to the shapes of the central region 24a, the flexible region 24b, and the peripheral portion 24c, whereby the diaphragm 24 is formed (FIG. 3C). After that, the first and second supporting members 44 and 46 and the fixing portion 28 are connected to predetermined positions of the diaphragm 24 by a fixing material such as an adhesive agent as shown in FIGS. 1, 2A, and 2B.

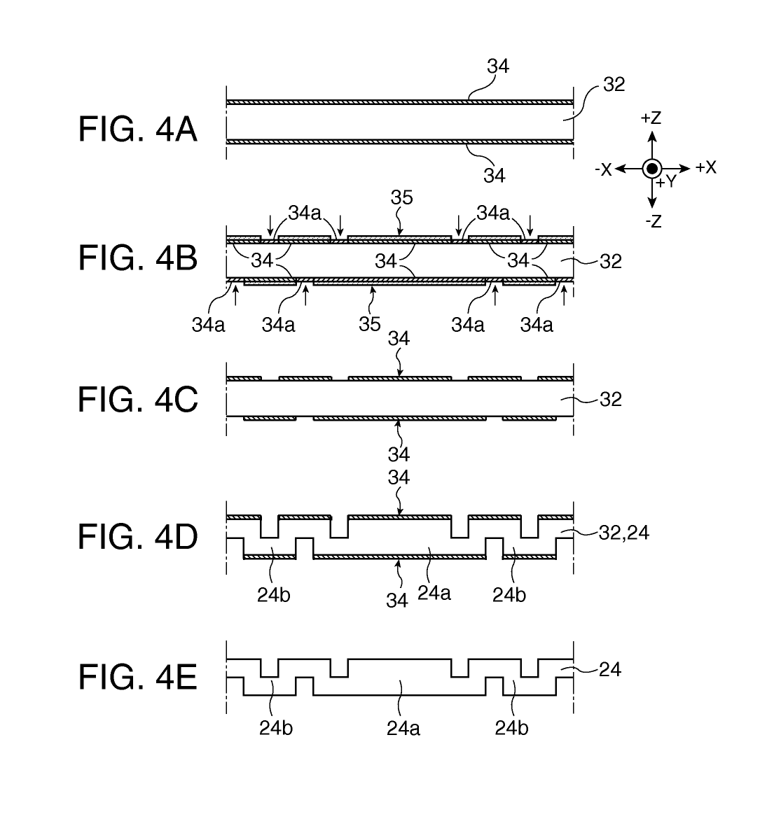

FIGS. 4A to 4E show schematic views when the diaphragm is formed of quartz crystal. When the diaphragm 24 is formed of quartz crystal, similarly, it is preferable to form the diaphragm 24 by photolithographic etching. In this case, a base substrate 32 as a material is prepared and a positive photoresist 34 is applied on the surface of the base substrate 32 (FIG. 4A). Subsequently, exposure is preformed using a photomask 35 corresponding in arrangement and shape to the central region 24a, the flexible region 24b, and the peripheral region (not shown) so as to expose the photoresist 34 (FIG. 4B). Subsequently, development is performed so as to remove the exposed photoresist 34a (FIG. 4C). Subsequently, a region on which the base substrate 32 is exposed is subjected to half-etching, whereby the central region 24a, the flexible region 24b, and the peripheral region (not shown) are integrally formed (FIG. 4D). Finally, the photoresist 34 is removed (FIG. 4E), whereby the diaphragm 24 is formed.

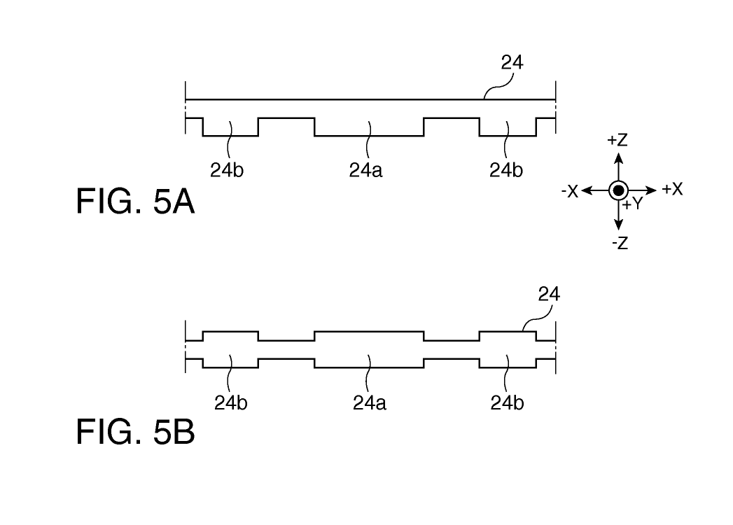

FIGS. 5A and 5B show modification examples when the diaphragm is formed of quartz crystal. As a modification example of photolithographic etching of the diaphragm 24, it is preferable to etch only one surface of the flexible region 24b as shown in FIG. 5A, and it is also preferable to etch the front and rear surfaces of the flexible region 24b at the mutually facing positions as shown in FIG. 5B.

In addition, the surface of the diaphragm 24 exposed to the outside may be coated with an anti-corrosion film so as not to be corroded by liquids, gases, or the like. For example, if the diaphragm 24 is formed of metal, the diaphragm 24 may be coated with a nickel compound. Moreover, if the diaphragm 24 is formed of a piezoelectric crystal body such as quartz crystal, the diaphragm 24 maybe coated with silicon.

As shown in FIGS. 1, 2A, and 2B, the first supporting member 44 is configured to fix the second base portion 40b of the first pressure sensitive element 40 described later. The first supporting member 44 includes a pedestal portion 44a that is fixed to the peripheral portion 24c of the diaphragm 24, a supporting column portion 46b that extends from the pedestal portion 44a in a displacement direction (Z-axis direction) of the central region 24a of the diaphragm 24, and an arm portion 44c that extends from the distal end of the supporting column portion 46b toward the central region 24a to be connected to and support the second base portion 40b of the first pressure sensitive element 40.

The supporting member 46 is configured to fix the second base portion 42b of the second pressure sensitive element 42 described later and the first base portion 40b of the first pressure sensitive element. The second supporting member 46 includes a pedestal portion 46a which is fixed to the central region 24a of the diaphragm 24 and to which the first base portion 40a of the first pressure sensitive element 40 is fixed, a supporting column portion 46b that extends from the pedestal portion 46a in a displacement direction of the central region 24a of the diaphragm 24, and an arm portion that extends from the distal end of the supporting column portion 46b toward the peripheral portion 24c to be connected to and support the second base portion 42b of the second pressure sensitive element 42.

The fixing portion 48 is fixed to the peripheral portion 24c of the diaphragm 24 at a position facing the distal end of the arm portion of the second supporting member, and the first base portion 42a of the second pressure sensitive element 42 is fixed to the fixing portion 48. It is assumed that the first and second supporting members 44 and 46 and the fixing portion 48 have predetermined rigidity, and will not be deformed in directions other than the displacement direction of the central region 24a of the diaphragm 24.

The materials of the first and second supporting members 44 and 46 are not particularly limited as long as predetermined rigidity can be obtained between the pedestal portion 44a, the supporting column portion 44b, and the arm portion 44c, and between the pedestal portion 46a, the supporting column portion 46b, and the arm portion 46c. However, the first and second pressure sensitive elements 40 and 42 are preferably formed of the same material as these portions in order to suppress thermal stress applied to the first and second pressure sensitive elements 40 and 42. Similarly, the fixing portion 48 is preferably formed of the same material as the pressure sensitive elements for the same reason.

The first and second pressure sensitive elements 40 and 42 can be formed of a piezoelectric material such as a quartz crystal, lithium niobate, or lithium tantalate.

As shown in FIGS. 1, 2A, and 2B, the first pressure sensitive element 40 includes vibrating arms 40c and first and second base portions 40a and 40b which are formed at both ends of the vibrating arms 40c. Similarly, the second pressure sensitive element 42 includes vibrating arms 42c and first and second base portions 42a and 42b which are formed at both ends of the vibrating arms 42c. Furthermore, the first and second pressure sensitive elements 40 and 42 include excitation electrodes (not shown) which are formed on the vibrating arms 40c and 42c and the electrode portions (not shown) which are electrically connected to the excitation electrodes (not shown).

The first pressure sensitive element 40 is disposed so that the longitudinal direction (Z-axis direction) thereof, namely the arrangement direction of the first and second base portions 40a and 40b, is coaxial to or parallel to the displacement direction of the diaphragm 24, and the displacement direction thereof is used as the detection axis. The first base portion 40a of the first pressure sensitive element 40 is fixed to the pedestal portion 46a of the second supporting member 46 and is in contact with the central region 24a of the diaphragm 24. Moreover, the second base portion 40b which is on the opposite side of the first base portion 40a with the vibrating arms 40c disposed therebetween is connected to the distal end of the arm portion 44c of the first supporting member 44.

Similarly to the first pressure sensitive element 40, the second pressure sensitive element 42 includes the vibrating arms 42c and the first and second base portions 42a and 42b formed at both ends of the vibrating arms 42c. The second pressure sensitive element 42 has its detection axis which is in parallel to a line connecting the first and second base portions 42a and 42b, similarly to the first pressure sensitive element 40. Moreover, it is assumed that the material and dimensions of the second pressure sensitive element 42 are the same as those of the first pressure sensitive element 40, and the two pressure sensitive elements have the same temperature property and the same aging property. The second pressure sensitive element 42 is disposed in parallel to the first pressure sensitive element 40, and the first base portion 42a is connected to the fixing portion 48 fixed to the peripheral portion 24c and is in contact with the peripheral portion 24c. Furthermore, the second base portion 42b of the second pressure sensitive element 42 is connected to the distal end of the arm portion 46c of the second supporting member 46.

In addition, since the first and second pressure sensitive elements 40 and 42 are fixed to the first and second supporting members 44 and 46 and the fixing portion 48, the respective pressure sensitive elements can be easily fixed to the side of the diaphragm 24. Moreover, since the first and second pressure sensitive elements 40 and 42 are not bent in directions other than the detection axis direction, it is possible to prevent the first and second pressure sensitive elements 40 and 42 from moving in directions other than the detection axis direction and to improve the sensitivity in the detection axis direction of the first and second pressure sensitive elements 40 and 42.

The first and second pressure sensitive elements 40 and 42 are electrically connected to the IC (not shown) through wires 38 and the hermetic terminals 36 described above and vibrate at a natural resonance frequency in response to an alternating voltage supplied from the IC (not shown). Moreover, the resonance frequencies of the first and second pressure sensitive elements 40 and 42 change when they receive extensional stress or compressive stress from the longitudinal direction thereof. In the present embodiment, a double-ended tuning fork vibrator can be used as the vibrating arms 40c and 42c serving as the pressure sensing portion. The double-ended tuning fork vibrator has characteristics such that the resonance frequency thereof changes substantially in proportion to tensile stress (extensional stress) or compressive stress which is applied to the two vibrating beams which are the vibrating arms 40c and 42c. Moreover, a double-ended tuning fork piezoelectric vibrator is ideal for a pressure sensor which has such an excellent resolution as to detect a small pressure difference since a change in the resonance frequency to extensional and compressive stress is very large as compared to a thickness shear vibrator or the like, and a variable width of the resonance frequency is large. In the double-ended tuning fork piezoelectric vibrator, the resonance frequency of the vibrating arm increases when it receives extensional stress, whereas the resonance frequency of the vibrating arm decreases when it receives compressive stress.

Moreover, in the present embodiment, the pressure sensing portion is not limited to one which has two rod-like vibrating beams, but a pressure sensing portion having one vibrating beam (single beam) may be used. If the pressure sensing portion (the vibrating arms 40c and 42c) is configured as a single-beam vibrator, the displacement thereof is doubled when the same amount of stress is applied from the longitudinal direction (detection axis direction). Therefore, it is possible to obtain a pressure sensor which is more sensitive than one having a double-ended tuning fork vibrator. In addition, among the piezoelectric materials described above, a quartz crystal having excellent temperature property is preferred as the material of a piezoelectric substrate of a double-ended or single-beam piezoelectric vibrator.

The pressure sensor 10 of the first embodiment is assembled in the following manner. First, the diaphragm 24 is connected to the ring portion 16, and the first and second supporting members 44 and 46 and the fixing portion 48 are connected to predetermined positions of the diaphragm 24. Moreover, the first base portion 40a of the first pressure sensitive element 40 is connected to the pedestal portion 46a of the second supporting member 46, and the second base portion 40b is connected to the arm portion 46c of the first supporting member 44. Furthermore, the first base portion 42a of the second pressure sensitive element 42 is connected to the fixing portion 48, and the second base portion 42b is connected to the arm portion 46c of the second supporting member 46.

Subsequently, the supporting shaft 18 is fixed by inserting into the hole 16a of the ring portion 16, and the other end of the supporting shaft 18 of which one end thereof has been inserted into the ring portion 16 is fixed by inserting into the hole 14c of the flange portion 14. Moreover, the portions of the hermetic terminals 36 disposed inside the housing 12 are electrically connected to the electrode portions (not shown) of the first pressure sensitive element 40 and the second pressure sensitive element 42 by the wires 38. In this case, the portions of the hermetic terminals 36 disposed outside the housing 12 are connected to the IC (not shown). Finally, the side surfaces 20 are inserted from the side of the ring portion 16 so as to be bonded to the inner periphery and outer periphery 14d of the flange portion 14 and the outer periphery 16b of the ring portion 16. In this way, the housing 12 is formed, and the pressure sensor 10 is assembled.

Next, the operation of the pressure sensor 10 according to the first embodiment will be described. In the first embodiment, when measuring fluid pressure with reference to atmospheric pressure, the central region 24a of the diaphragm 24 is displaced toward the inner side of the housing 12 if the fluid pressure is lower than the atmospheric pressure. In contrast, the central region 24a is displaced toward the outer side of the housing 12 if the fluid pressure is higher than the atmospheric pressure.

Moreover, when the central region 24a of the diaphragm 24 is displaced toward the outer side of the housing 12, the first pressure sensitive element 40 receives tensile stress from the central region 24a and the first supporting member 44 that is supported by the peripheral portion 24c (the fixing portion 48), and the second pressure sensitive element 42 receives compressive stress from the central region 24a through the second supporting member 46 that is supported by the central region 24a of the diaphragm 24. In contrast, when the central region 24a is displaced toward the inner side of the housing 12, the first pressure sensitive element 40 receives compressive stress from the first supporting member 44, and the second pressure sensitive element 42 receives tensile stress from the central region 24a through the second supporting member 46.

The resonance frequencies of the respective pressure sensitive elements increase in response to tensile stress and decrease in response to compressive stress. Therefore, the pressure applied to the central region 24a can be detected by calculating a difference between the resonance frequencies of the first and second pressure sensitive elements 40 and 42. If the first and second pressure sensitive elements 40 and 42 are the same constituent elements, since they have the same temperature property and the same aging property with respect to the resonance frequency, these characteristics are canceled in relation to the difference.

Therefore, the pressure sensor 10 can measure pressure stably regardless of the temperature property, the aging property, and the like. Moreover, since pressure is measured based on the difference between the resonance frequencies of two pressure sensitive elements, it is possible to obtain higher sensitivity than when using one pressure sensitive element. Furthermore, since at least one base portion of the first and second pressure sensitive elements 40 and 42 is fixed to the side of the diaphragm 24, it is possible to decrease the overall size of the pressure sensor 10.

Here, a change in the resonance frequency of the first pressure sensitive element 40 relative to the second pressure sensitive element 42 will be discussed. A change ΔF in the resonance frequency of each pressure sensitive element can be expressed as the sum of a frequency change ΔF(P) due to pressure P applied from the diaphragm, a frequency change ΔF(T) due to temperature T, a frequency change ΔF(τ) due to aging (τ), and a frequency change ΔF(μ) due to air viscosity (μ). That is, the resonance frequency changes ΔF₁ and ΔF₂ of the first and second pressure sensitive elements 40 and 42 are expressed by Expression (1) below.

$$\{ \begin{matrix}Δ {F}_{1} = Δ {F}_{1} ( P ) + Δ {F}_{1} ( T ) + Δ {F}_{1} ( τ ) + Δ {F}_{1} ( μ ) \\ Δ {F}_{2} = Δ {F}_{2} ( P ) + Δ {F}_{2} ( T ) + Δ {F}_{2} ( τ ) + Δ {F}_{2} ( μ )\end{matrix} \qquad ( 1 )$$

Here, since the first and second pressure sensitive elements 40 and 42 are formed of elements having the same property, although frequency changes ΔF(T), ΔF(τ), and ΔF(μ) are the same, the frequency changes ΔF(P) thereof due to pressure P have different signs because of their structure in the present embodiment. That is, Expression (2) below is satisfied.

$$\{ \begin{matrix}Δ {F}_{1} ( P ) = - Δ {F}_{2} ( P ) \\ Δ {F}_{1} ( T ) = Δ {F}_{2} ( T ) \\ Δ {F}_{1} ( τ ) = Δ {F}_{2} ( τ ) \\ Δ {F}_{2} ( μ ) = Δ {F}_{2} ( μ )\end{matrix} \qquad ( 2 )$$

Therefore, when Expression (2) is substituted into Expression (1), the difference between the resonance frequency changes ΔF₁ and ΔF₂ of the first and second pressure sensitive elements 40 and 42 is calculated as Expression (3) below.

ΔF₁−ΔF₂=2ΔF₁(P) (3)

Therefore, when the difference between the resonance frequencies of the first and second pressure sensitive elements 40 and 42 is calculated, only the frequency change component ΔF(P) due to pressure P remains, and the other components are canceled. Thus, it can be understood that errors in pressure values due to changes in temperature and changes with time of the respective pressure sensitive elements and the effect of air viscosity can be eliminated. Furthermore, since the ΔF(P) component is doubled, it can be understood that the pressure measurement sensitivity is improved so as to be double.

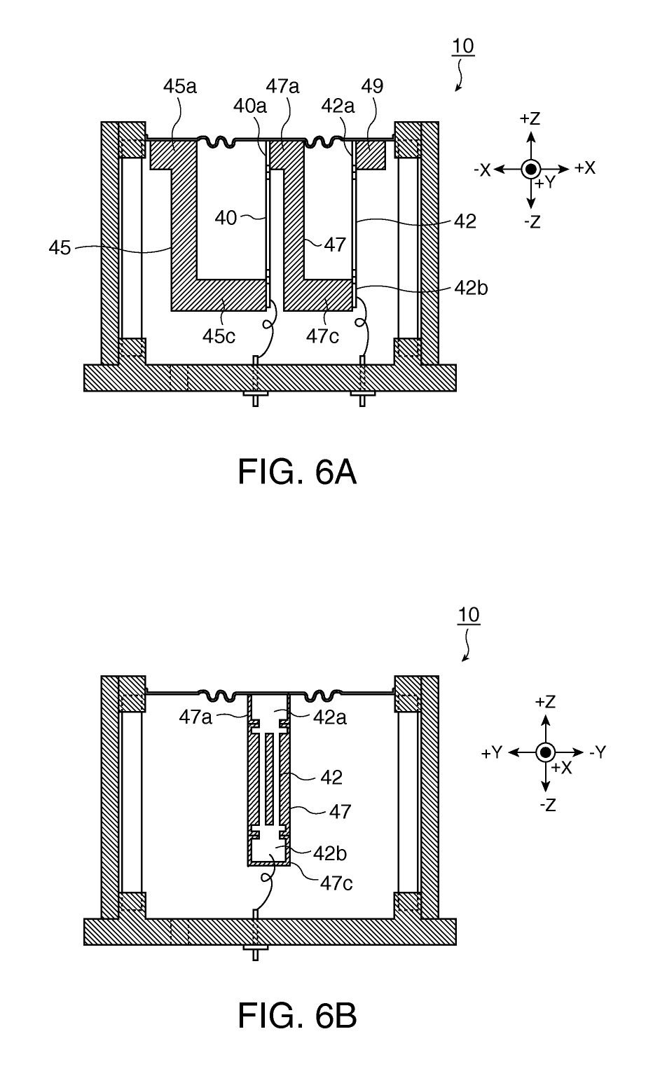

FIGS. 6A and 6B show a pressure sensor according to a modification example of the first embodiment. FIGS. 6A and 6B are cross-sectional views taken along the XZ and YZ planes, respectively. In FIGS. 1, 2A, and 2B, the first and second pressure sensitive elements 40 and 42 are connected to the side of the arm portion. However, as shown in FIGS. 6A and 6B, the first base portion 40a of the first pressure sensitive element 40 may be connected to the end portion of the pedestal portion 47a of the second supporting member 47, and the second base portion 40b may be connected to the side of the end portion of the arm portion 45c of the first supporting member 45. Similarly, the first base portion 42a of the second pressure sensitive element 42 may be connected to the end portion of the fixing portion 49 of the first base portion 42a, and the second base portion 42b may be connected to the end portion of the arm portion 47c of the second supporting member 47. In addition, either one of the first and second pressure sensitive elements 40 and 42 may be connected as shown in FIGS. 6A and 6B.

### Second Embodiment

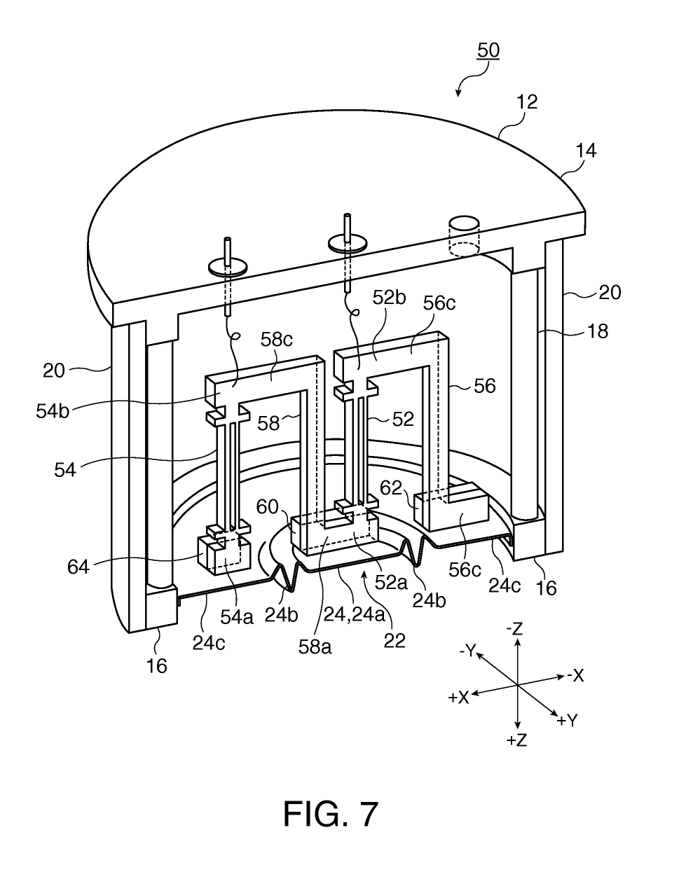

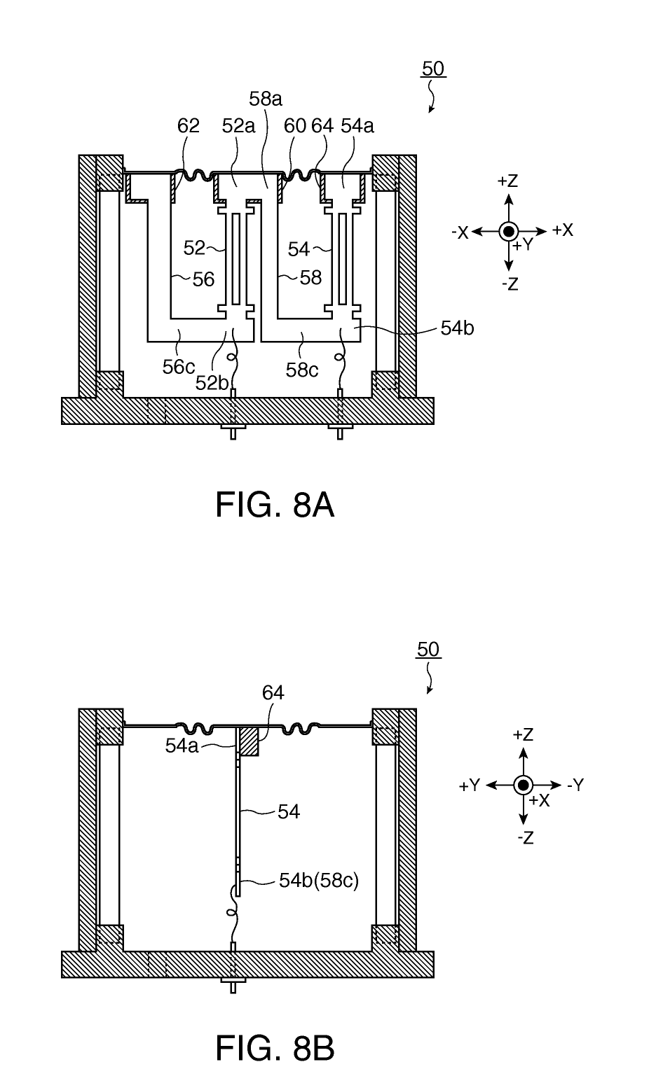

FIG. 7 shows a perspective cross-sectional view of a pressure sensor according to a second embodiment taken along the XZ plane. FIGS. 8A and 8B show cross-sectional views of the pressure sensor according to the second embodiment, taken along the XZ and YZ planes, respectively. In a pressure sensor 50 according to the second embodiment, although the housing 12 and the diaphragm 24 are the same as those of the first embodiment, first and second pressure sensitive elements 52 and 54 and first and second supporting members 56 and 58 are integrally formed of a piezoelectric material different from the first embodiment.

When integrally forming the first and second pressure sensitive elements 52 and 54 and the first and second supporting members 56 and 58, a first base portion 52a of the first pressure sensitive element 52 is integrated with a pedestal portion 58a of the second supporting member 58, and a second base portion 52b of the first pressure sensitive element 52 is integrated with the distal end of an arm portion 56c of the first supporting member 56. Moreover, a second base portion 54b of the second pressure sensitive element 54 is integrated with the distal end of an arm portion 58c of the second supporting member 58.

With this configuration, since the respective pressure sensitive elements and the respective supporting members have the same thermal expansion coefficient, it is possible to prevent thermal deformation between the respective pressure sensitive elements and the respective supporting members and to improve the temperature property. Moreover, by integrally forming the respective pressure sensitive elements and the respective supporting members, it is possible to decrease the number of components of the pressure sensor 50, increase the assembly efficiency of the pressure sensor 50, and achieve cost reduction.

Furthermore, the first base portion 52a (the pedestal portion 58a of the second supporting member 58) of the first pressure sensitive element 52, the first base portion 54a of the second pressure sensitive element 54, and the pedestal portion 56a of the first supporting member 56 are formed so that the end portions thereof on the sides connected to the diaphragm 24 are arranged on the same straight line. In addition, in the integral member formed by these portions, the above-mentioned portions are connected to the diaphragm 24 (fixing portions 60, 62, and 64 described later) so that the straight line is vertical to the displacement direction of the diaphragm 24.

With this configuration, since the respective pressure sensitive elements and the respective supporting members will not receive thermal deformation from the diaphragm 24, the pressure sensor 50 can measure pressure with high accuracy stably against a change in temperature.

The fixing portion 60 for fixing the integral member is fixed to the central region 24a by an adhesive agent or the like, and the fixing portions 62 and 64 are fixed to the peripheral portion 24c by an adhesive agent or the like. The fixing portion 60 is connected to the pedestal portion 58a (the first base portion 52a of the first pressure sensitive element 52) of the second supporting member 58. The fixing portion 62 is connected to the pedestal portion 56a of the first supporting member 56. The fixing portion 62 is connected to the first base portion 54a of the second pressure sensitive element 54. These fixing portions 60, 62, and 64 are preferably formed of the same material as the diaphragm 24 similarly to the first embodiment.

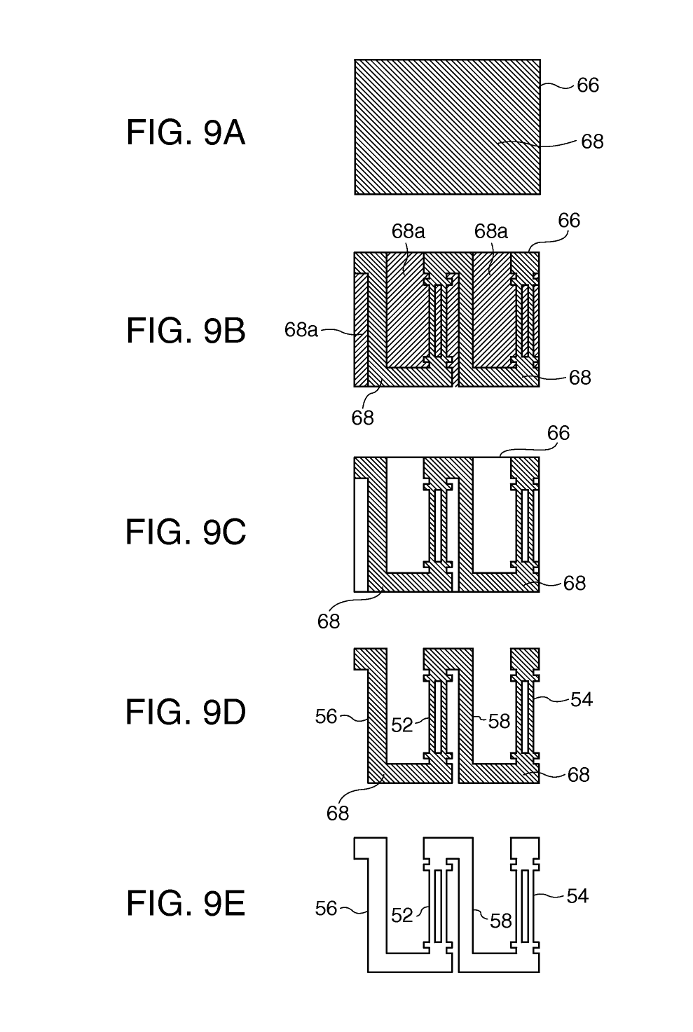

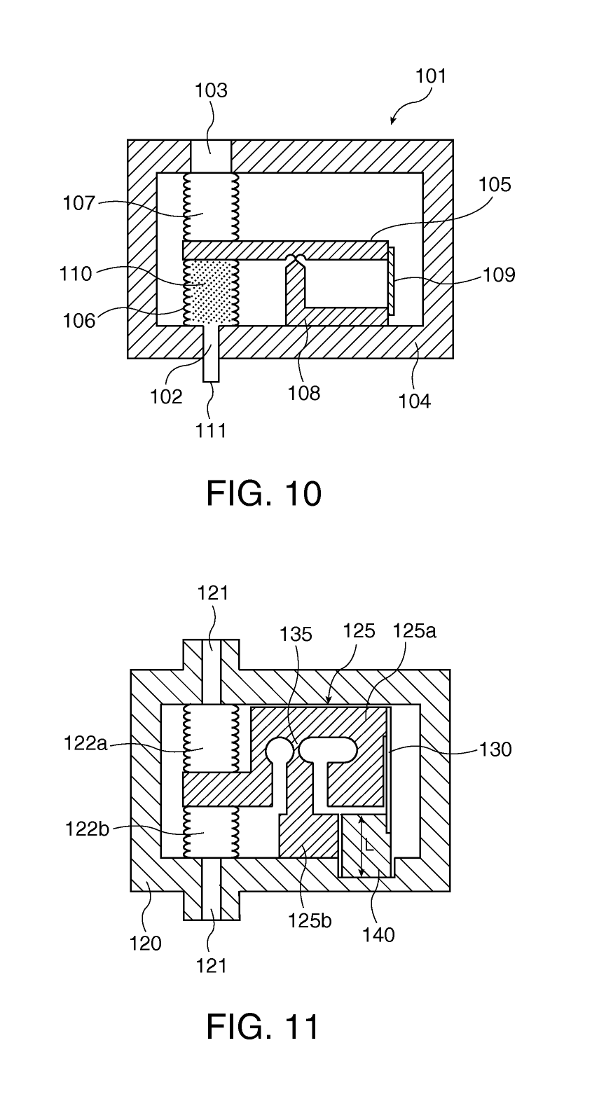

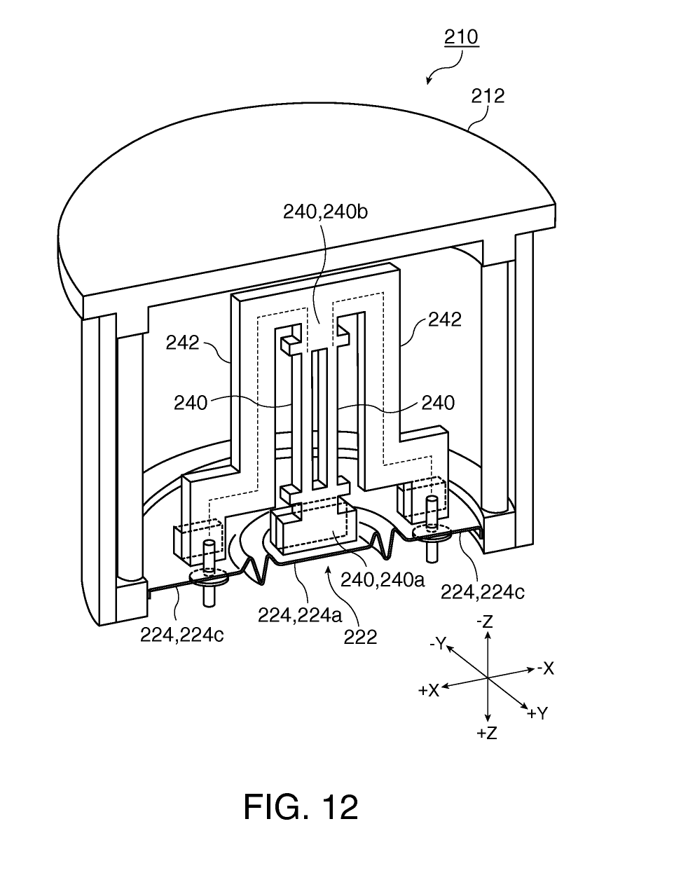

FIGS. 9A to 9E show schematic views when the integral member that integrates the first and second pressure sensitive elements 52 and 54 and the first and second supporting members 56 and 58 is formed of quartz crystal. When the integral member is formed of quartz crystal, it is preferable to form the integral member by photolithographic etching similarly to the diaphragm 24 of the first embodiment. In this case, a base substrate 66 serving as a material is prepared and a positive photoresist 68 is applied on the surface of the base substrate (FIG. 9A). Subsequently, exposure is preformed using a photomask (not shown) corresponding in shape to the first and second pressure sensitive elements 52 and 54 and the first and second supporting members 56 and 58 so as to expose the photoresist 68 (FIG. 9B). Subsequently, development is performed so as to remove the exposed photoresist 68a (FIG. 9C). Subsequently, a region on which the base substrate 66 is exposed is subjected to etching, whereby the first and second pressure sensitive elements 52 and 54 and the first and second supporting members 56 and 58 are integrally formed (FIG. 9D). Finally, the photoresist 68 is removed (FIG. 9E), whereby the integral member is formed.

The pressure sensor 50 of the second embodiment is assembled essentially similarly to the first embodiment. That is, the diaphragm 24 is connected to the ring portion 16, the fixing portion 60 is connected to the central region 24a, and the fixing portions 62 and 64 are connected to predetermined positions of the peripheral portion 24c. Moreover, the pedestal portion 58a (the first base portion 52a of the first pressure sensitive element 52) of the second supporting member 58 is connected to the side surface of the fixing portion 60, the first base portion 54a of the second pressure sensitive element 54 is connected to the side surface of the fixing portion 62, and the pedestal portion 56a of the first supporting member 56 is connected to the side surface of the fixing portion 64. In this case, the end portions of the pedestal portion 56a, the first base portion 54a, and the pedestal portion 58a disposed close to the diaphragm 24 may be in contact with the diaphragm 24.

The entire disclosure of Japanese Patent Application No. 2010-178591, filed Aug. 9, 2010 is expressly incorporated by reference herein.

1. A pressure sensor comprising:
a pressure receiving member having a flexible portion that is displaced in response to force and a peripheral portion connected to an outer periphery of the flexible portion; and
first and second pressure sensitive elements which have a pressure sensing portion and a pair of base portions connected to both ends of the pressure sensing portion, and which have a detection axis parallel to a line connecting the base portions, and in which the detection axis is parallel to a displacement direction of the flexible portion,
wherein one base portion of the first pressure sensitive element is fixed to the flexible portion, and the other base portion is fixed to a first supporting member that is supported by the peripheral portion, and
wherein one base portion of the second pressure sensitive element is fixed to the peripheral portion, and the other base portion is fixed to a second supporting member that is supported by the flexible portion.

2. The pressure sensor according to claim 1,
wherein the pressure sensing portion includes at least one columnar beam.

3. The pressure sensor according to claim 1,
wherein the first and second pressure sensitive elements and the first and second supporting members are integrally formed of a piezoelectric material.

4. The pressure sensor according to claim 3,
wherein the first and second pressure sensitive elements and the first and second supporting members are formed so that end portions thereof on the sides connected to the pressure receiving member are arranged on a straight line that is vertical to the displacement direction of the flexible portion.

5. The pressure sensor according to claim 2,
wherein the first and second pressure sensitive elements and the first and second supporting members are integrally formed of a piezoelectric material.
